(19) United States
(12) Patent Application Publication
(10) Pub. No.: US 2026/0198451 A1
(43) Pub. Date: Jul. 16, 2026

(54) Peltier pet mat that facilitates temperature regulation

(71) Applicant: Yanyu Xie, Jieyang (CN)

(72) Inventor: Yanyu Xie, Jieyang (CN)

(21) Appl. No.: 19/021,133

(22) Filed: Jan. 14, 2025

(51) Int. Cl. A01K 1/035; A01K 1/00

(52) U.S. Cl. CPC A01K 1/0353; A01K 1/0052; A01K 1/0076

(57) ABSTRACT

Disclosed is a Peltier pet mat that facilitates temperature regulation, including: a mat and a support frame mounted in the mat, where the support frame is formed by combining support legs, two long support rods and two short support rods, where the long support rods are arranged to be perpendicular to the short support rods; a Peltier module for cooling or heating, where the Peltier module is composed of a temperature regulation structure and a heat dissipation structure, and the Peltier module is electrically connected to a switch through a data line; the switch is composed of a housing and a circuit board arranged inside the housing, and the switch changes a direction of current flowing through the Peltier module; and the present disclosure not only provides a more stable and sturdy support structure, but also achieves functions of flexible cooling and heating through the integrated Peltier module.

### TECHNICAL FIELD

The present disclosure relates to the technical field of pet mats, and in particular to a Peltier pet mat that facilitates temperature regulation.

### BACKGROUND

Owners have been paying an increasing attention to various aspects of their pets including their living quality. More and more owners are increasingly concerned about resting environments of their pets because resting environments play a significant role in influencing physical and mental health of pets. Comfortable, quiet, and clean resting environments are crucial for healthy growth of pets.

However, most traditional pet mats only have basic bedding functions and cannot regulate temperature according to pets’ body temperatures or environmental changes, which, to some extent, limits comfort of pets and cannot meet temperature needs of pets in different seasons or environments.

Therefore, to solve the above problems that most traditional pet mats only have basic bedding functions and cannot regulate temperature according to pets’ body temperatures or environmental changes, a Peltier pet mat that facilitates temperature regulation can be designed. The present disclosure achieves functions of flexible cooling and heating through an integrated Peltier module, which ensures that the pet can enjoy an appropriate temperature in different seasons or environments.

### SUMMARY

In order to solve the problems that most traditional pet mats only have basic bedding functions and cannot regulate temperature according to pets’ body temperatures or environmental changes, the present disclosure provides a cooling mattress for pets based on Peltier semiconductor cooling technology.

The present disclosure provides the following technical solution as follows: a Peltier pet mat that facilitates temperature regulation, including: a mat and a support frame mounted in the mat, where the support frame is formed by combining support legs, two long support rods and two short support rods, where the long support rods are arranged to be perpendicular to the short support rods; a Peltier module configured for cooling or heating is arranged in a middle of the mat, the Peltier module is composed of a temperature regulation structure and a heat dissipation structure, and the Peltier module is electrically connected to a switch through a data line; and the switch is composed of a housing and a circuit board arranged inside the housing, and the switch changes a direction of current flowing through the Peltier module.

Preferably, the housing of the switch is formed by combining an upper part and a lower part, and the circuit board is composed of a power output terminal, a button, a control module, and an H-bridge circuit.

Preferably, the temperature regulation structure includes a fixing member, a lower surface of the mat is provided with the fixing member, a module housing is mounted at a lower end of the fixing member, the semiconductor TEC is mounted in the module housing, the semiconductor TEC is electrically connected to the data line, and a temperature-conductive medium surface is mounted at an upper end of the semiconductor TEC.

Preferably, the heat dissipation structure includes a heat dissipation fin, the heat dissipation fin is arranged on a side of the semiconductor TEC opposite to the temperature-conductive medium surface, a heat dissipation fan is arranged below the heat dissipation fin, and the heat dissipation fan is electrically connected to the data line.

Preferably, a heat dissipation groove for ventilation is formed on a side wall of the module housing, and rotation of the heat dissipation fan drives heat to dissipate from the heat dissipation groove.

Preferably, each of the support legs includes a three-way connector, a support column is mounted at a lower end of the three-way connector, and a lower end of the support column is integrally fixedly connected to an anti-slip foot sleeve.

The present disclosure has the following beneficial effects: the pet mat of this solution, compared to traditional pet mats, not only has a more stable and sturdy support structure, but also achieves functions of flexible cooling and heating through the integrated Peltier module, which ensures that the pet can enjoy an appropriate temperature in different seasons or environments, and provides a safer and more comfortable resting experience for the pet.

### BRIEF DESCRIPTION OF THE DRAWINGS

FIG. 1 is a schematic diagram of a first three-dimensional structure of a Peltier pet mat that facilitates temperature regulation of the present disclosure.

FIG. 2 is a schematic diagram of a second three-dimensional structure of a Peltier pet mat that facilitates temperature regulation of the present disclosure.

FIG. 3 is a schematic diagram of a three-dimensional structure of a support leg of a Peltier pet mat that facilitates temperature regulation of the present disclosure.

FIG. 4 is a schematic diagram of a three-dimensional structure of a switch of a Peltier pet mat that facilitates temperature regulation of the present disclosure.

FIG. 5 is a schematic diagram of breakdown of a three-dimensional structure of a switch of a Peltier pet mat that facilitates temperature regulation of the present disclosure.

FIG. 6 is a schematic diagram of a three-dimensional structure of a Peltier module of a Peltier pet mat that facilitates temperature regulation of the present disclosure.

FIG. 7 is a schematic diagram of breakdown of a three-dimensional structure of a Peltier module of a Peltier pet mat that facilitates temperature regulation of the present disclosure.

Reference numerals in the figures: 1. mat; 2. support leg; 3. long support rod; 4. short support rod; 5. Peltier module; 6. switch; 7. housing; 8. circuit board; 9. fixing member; 10. module housing; 11. semiconductor TEC; 12. data line; 13. temperature-conductive medium surface; 14. heat dissipation fin; 15. heat dissipation fan; 16. three-way connector; 17. support column; 18. anti-slip foot sleeve; 19. power output terminal; 20. button; 21. control module; and 22. H-bridge circuit.

### DETAILED DESCRIPTIONS OF THE EMBODIMENTS

The present disclosure will be further described below with reference to the accompanying drawings and embodiments.

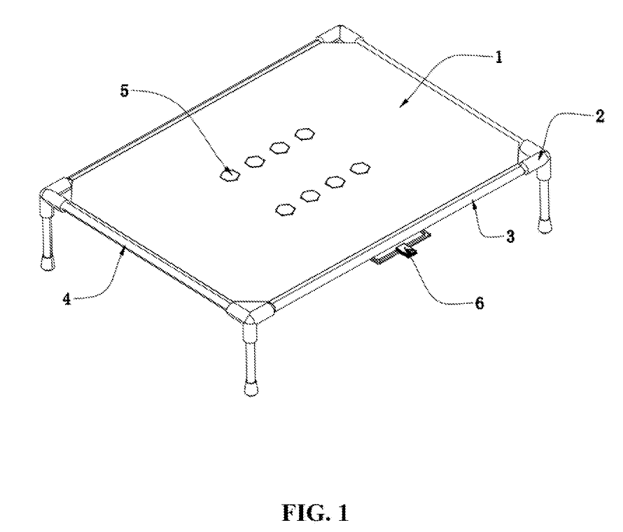

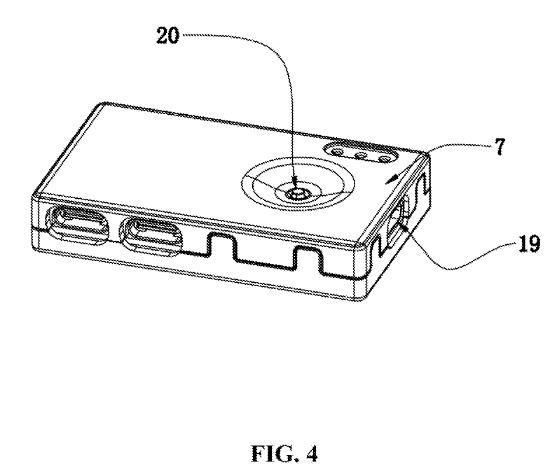

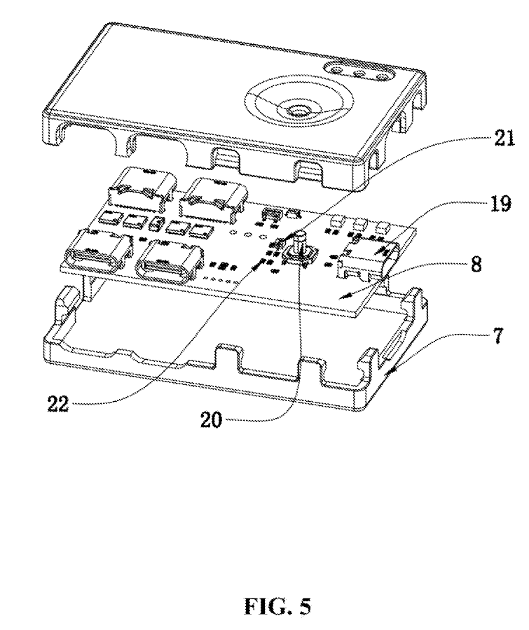

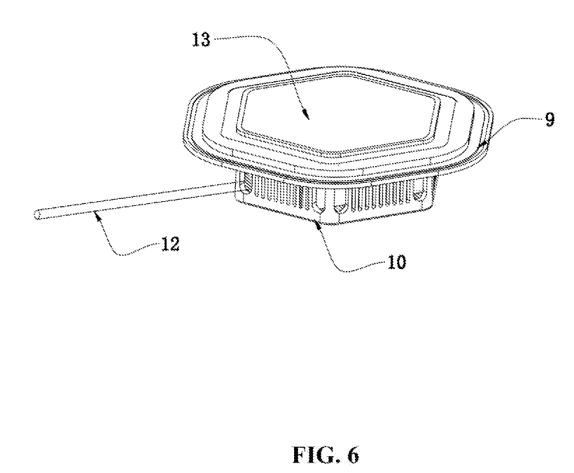

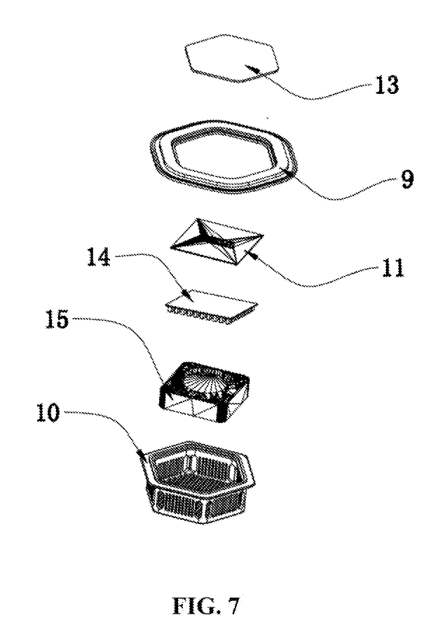

With reference to FIGS. 1-7, the present disclosure provides an example: a Peltier pet mat that facilitates temperature regulation, includes: a mat 1 and a support frame mounted in the mat 1, where the support frame is formed by combining support legs 2, two long support rods 3 and two short support rods 4, where the long support rods 3 are arranged to be perpendicular to the short support rods 4; a Peltier module 5 configured for cooling or heating arranged in a middle of the mat 1, where the Peltier module 5 is composed of a temperature regulation structure and a heat dissipation structure, and the Peltier module 5 is electrically connected to a switch 6 through a data line 12; the switch 6 is composed of a housing 7 and a circuit board 8 arranged inside the housing 7, and the switch 6 changes a direction of current flowing through the Peltier module 5; the mat 1, as a main part of the pet mat, is made of a soft and durable material, which provides a comfortable resting environment for a pet; the support frame is mounted inside the mat 1, which forms a stable and sturdy support structure; the Peltier module 5 is arranged in the middle of the mat 1, and the Peltier module 5 is a core component of the pet mat that achieves a cooling or heating function; the temperature regulation structure, by precisely controlling a direction and magnitude of the current, adjusts a cooling or heating effect of the Peltier module 5, to meet temperature needs of the pet in different seasons or environments; the heat dissipation structure effectively dissipates heat generated by the Peltier module 5 during operation, to ensure that the pet mat can work continuously and stably; the Peltier module 5 is electrically connected to the switch 6 through the data line 12, the switch 6 is composed of the housing 7 and the circuit board 8 arranged inside the housing 7, and the circuit board 8 integrates a circuitry that controls the operation of the Peltier module 5; a user can easily change the direction of the current flowing through the Peltier module 5 by operating the switch 6, and achieve switching between a cooling mode and a heating mode; and this design is not only user-friendly, but also ensures that the pet mat can provide an appropriate temperature in various environments, such that the pet can enjoy a more comfortable resting experience.

With reference to FIGS. 1, 4 and 5, in this example, the housing 7 of the switch 6 is formed by combining an upper part and a lower part, and the circuit board 8 is composed of a power output terminal 19, a button 20, a control module 21, and an H-bridge circuit 22; when a user presses the button 20, the pet mat is powered on, and the current begins to flow into the entire circuit from a power source; the control module 21 is configured for controlling an operating mode of the pet mat, i.e., a cooling or heating mode; the H-bridge circuit 22 is a special circuit that can change the direction of the current, and combined control of the switch 6 determines how the current flows through a semiconductor TEC 11; the H-bridge circuit 22 is provided with four electronic switches labeled as S1, S2, S3 and S4 respectively; in the cooling mode, the control module 21 sends a command to turn off S2 and S3 and turn on S1 and S4, and the current flows into the H-bridge circuit 22 from the power source and from S1 to a positive pole of the semiconductor TEC 11, then flows out from a negative pole of the semiconductor TEC 11, and returns to the power source through S4, such that a cold end of the semiconductor TEC 11 starts absorbing heat and a hot end thereof begins to dissipate heat, thereby creating a cooling effect; and in the heating mode, the control module 21 sends a command to turn off S1 and S4 and turn on S2 and S3, the current flows in a reverse direction, that is, the current flows from S2 into the negative pole of the semiconductor TEC 11, then flows out from the positive pole of the semiconductor TEC 11, and returns to the power source through S3, such that the hot end of the semiconductor TEC 11 starts generating heat and the cold end thereof releases heat, thereby creating a heating effect.

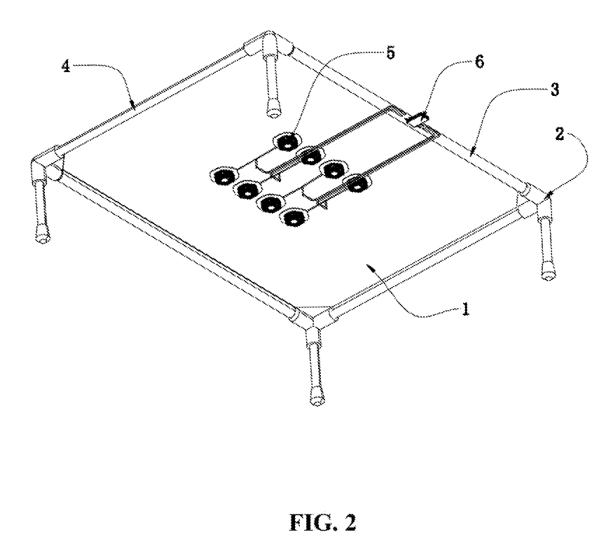

With reference to FIGS. 2, 6, and 7, in this example, the temperature regulation structure includes a fixing member 9, a lower surface of the mat 1 is provided with the fixing member 9, a module housing 10 is mounted at a lower end of the fixing member 9, the semiconductor TEC 11 is mounted in the module housing 10, the semiconductor TEC 11 is electrically connected to the data line 12, and a temperature-conductive medium surface 13 is mounted at an upper end of the semiconductor TEC 11; the heat dissipation structure includes a heat dissipation fin 14, the heat dissipation fin 14 is arranged on a side of the semiconductor TEC 11 opposite to the temperature-conductive medium surface 13, a heat dissipation fan 15 is arranged below the heat dissipation fin 14, and the heat dissipation fan 15 is electrically connected to the data line 12; a heat dissipation groove for ventilation is formed on a side wall of the module housing 10, and rotation of the heat dissipation fan 15 drives heat to dissipate from the heat dissipation groove; a core principle of a Peltier semiconductor refrigeration chip is “Peltier effect”, and when current flows through two types of conductors (N-type and P-type semiconductors) in the semiconductor TEC 11, the direction of the current determines a side of heat absorption (cooling) or heat dissipation (heating); in the cooling mode, the current flows to the cold end, heat from the cold end is “extracted” and released to the hot end, the cold end becomes cooler, and the hot end becomes hotter; in the heating mode, the current flows in the reverse direction, the hot end starts generating heat, and the cold end starts releasing heat; and during cooling, the hot end of the semiconductor TEC 11 dissipates heat through the heat dissipation fin 14, and in this case, the heat dissipation fan 15 works to blow away the heat on the heat dissipation fin 14, thereby achieving the cooling effect.

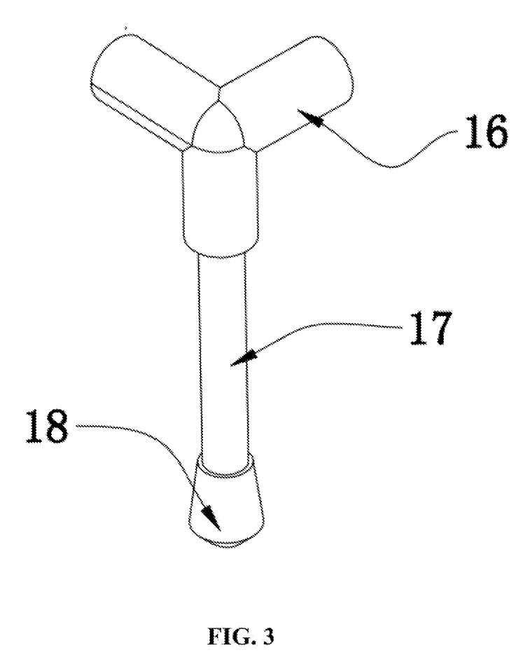

With reference to FIGS. 1 and 3, in this example, each of the support legs 2 includes a three-way connector 16, a support column 17 is mounted at a lower end of the three-way connector 16, a lower end of the support column 17 is integrally fixedly connected to an anti-slip foot sleeve 18, and the support legs 2 constitute an important part of the support frame of the pet mat and have a function of stably placing the mat 1 on the ground; the support column 17 acts as a component connecting the three-way connector 16 with the ground, forming a stable support point; and the anti-slip foot sleeve 18 is made of a high-friction material, and its surface is designed to have anti-slip textures to effectively increase the friction with the ground, thereby ensuring that the pet mat is placed in a more stable manner.

In operation, the switch 6 is connected to the power supply, and then the button 20 is pressed to determine whether to activate the heating or cooling function.

In the cooling mode, the control module 21 sends a command to turn off S2 and S3 and turn on S1 and S4, and the current flows into the H-bridge circuit 22 from the power source and from S1 to the positive pole of the semiconductor TEC 11, then flows out from the negative pole of the semiconductor TEC 11, and returns to the power source through S4, such that the cold end of the semiconductor TEC 11 starts absorbing heat and the hot end thereof begins to dissipate heat, thereby creating the cooling effect; meanwhile, the heat dissipation fan 15 works to blow away the heat from the heat dissipation fin 14, thereby achieving the cooling effect;

and in the heating mode, the control module 21 sends a command to turn off S1 and S4 and turn on S2 and S3, the current flows in a reverse direction, that is, the current flows from S2 into the negative pole of the semiconductor TEC 11, then flows out from the positive pole of the semiconductor TEC 11, and returns to the power source through S3, such that the hot end of the semiconductor TEC 11 starts generating heat and the cold end thereof releases heat, thereby creating the heating effect.

Based on the above steps, the pet mat of this solution, compared to traditional pet mats, not only has a more stable and sturdy support structure, but also achieves functions of flexible cooling and heating through the integrated Peltier module 5, which ensures that the pet can enjoy an appropriate temperature in different seasons or environments, provides a safer and more comfortable resting experience for the pet, and solves the problems that most traditional pet mats only have basic bedding functions and cannot regulate temperature according to pets’ body temperatures or environmental changes.

The embodiments of the present disclosure are described in detail with reference to the drawings above, but the present disclosure is not limited to the above embodiments. Various changes can be made within the knowledge scope of those skilled in the art without departing from the purpose of the present disclosure.

What is claimed is:

1. A Peltier pet mat that facilitates temperature regulation, comprising: a mat and a support frame mounted in the mat, wherein the support frame is formed by combining support legs, two long support rods and two short support rods, wherein the long support rods are arranged to be perpendicular to the short support rods; a Peltier module configured for cooling or heating arranged in a middle of the mat, wherein the Peltier module is composed of a temperature regulation structure and a heat dissipation structure, and the Peltier module is electrically connected to a switch through a data line; and the switch is composed of a housing and a circuit board arranged inside the housing, and the switch changes a direction of current flowing through the Peltier module.

2. The Peltier pet mat that facilitates temperature regulation according to claim 1, wherein the housing of the switch is formed by combining an upper part and a lower part, and the circuit board is composed of a power output terminal, a button, a control module, and an H-bridge circuit.

3. The Peltier pet mat that facilitates temperature regulation according to claim 2, wherein the temperature regulation structure comprises a fixing member, a lower surface of the mat is provided with the fixing member, a module housing is mounted at a lower end of the fixing member, the semiconductor TEC is mounted in the module housing, the semiconductor TEC is electrically connected to the data line, and a temperature-conductive medium surface is mounted at an upper end of the semiconductor TEC.

4. The Peltier pet mat that facilitates temperature regulation according to claim 3, wherein the heat dissipation structure comprises a heat dissipation fin, the heat dissipation fin is arranged on a side of the semiconductor TEC opposite to the temperature-conductive medium surface, a heat dissipation fan is arranged below the heat dissipation fin, and the heat dissipation fan is electrically connected to the data line.

5. The Peltier pet mat that facilitates temperature regulation according to claim 4, wherein a heat dissipation groove for ventilation is formed on a side wall of the module housing, and rotation of the heat dissipation fan drives heat to dissipate from the heat dissipation groove.

6. The Peltier pet mat that facilitates temperature regulation according to claim 5, wherein each of the support legs comprises a three-way connector, a support column is mounted at a lower end of the three-way connector, and a lower end of the support column is integrally fixedly connected to an anti-slip foot sleeve.
